(19) United States
(12) Patent Application Publication
(10) Pub. No.: US 2013/0251975 A1
(43) Pub. Date: Sep. 26, 2013

(54) PRODUCING RIGID POLYURETHANE FOAMS AND RIGID POLYISOCYANURATE FOAMS

(71) Applicant: BASF SE, Ludwigshafen (DE)

(72) Inventor: Gunnar KAMPF, Stemwede-Haldem (DE)

(73) Assignee: BASF SE, Ludwigshafen (DE)

(21) Appl. No.: 13/848,427

(22) Filed: Mar. 21, 2013

Related U.S. Application Data
(60) Provisional application No. 61/614,539, filed on Mar. 23, 2012.

(51) Int. Cl. C08J 9/14; B32B 5/18; C08J 9/08

(52) U.S. Cl. CPC C08J 9/141; C08J 9/08; B32B 5/18
USPC 428/304.4; 521/172; 521/130

(57) ABSTRACT

The present invention relates to a process for producing rigid polyurethane foams or rigid polyisocyanurate foams by the reaction of at least one polyisocyanate A), polyetherester polyols B) based on aromatic dicarboxylic acids obtainable by esterification of
b1) 10 to 70 mol % of a dicarboxylic acid composition comprising
   b11) 50 to 100 mol %, based on the dicarboxylic acid composition, of one or more aromatic dicarboxylic acids or derivatives thereof,
   b12) 0 to 50 mol %, based on said dicarboxylic acid composition b1), of one or more aliphatic dicarboxylic acids or derivatives thereof,
b2) 2 to 30 mol % of one or more fatty acids and/or fatty acid derivatives,
b3) 10 to 70 mol % of one or more aliphatic or cycloaliphatic diols having 2 to 18 carbon atoms or alkoxylates thereof,
b4) 2 to 50 mol % of a polyether polyol having a functionality of not less than 2, prepared by alkoxylating a polyol having a functionality of not less than 2 in the presence of an amine as catalyst,
   optionally further polyester polyols C) other than those of component B), and at least one polyether polyol D), wherein the mass ratio of total components B) and optionally C) to component D) is at least 7. The present invention also relates to the rigid foams thus obtainable and also to their use for producing sandwich elements having rigid or flexible outer layers. The present invention further relates to the underlying polyol components.

### CROSS REFERENCE TO RELATED APPLICATIONS

This application claims priority to U.S. Application No. 61/614,539, filed Mar. 23, 2012, the disclosure of which is incorporated herein by reference in its entirety.

### BACKGROUND OF THE INVENTION

### Description

The present invention relates to a process for producing rigid polyurethane foams or rigid polyisocyanurate foams using certain polyetherester polyols based on aromatic dicarboxylic acids. The present invention also relates to the rigid foams thus obtainable and also to their use for producing sandwich elements having rigid or flexible outer layers. The present invention further relates to the underlying polyol components.

The production of rigid polyurethane foams by reacting organic or modified organic di- or polyisocyanates with comparatively high molecular weight compounds having two or more than two reactive hydrogen atoms, especially with polyether polyols from alkylene oxide polymerization or polyester polyols from the polycondensation of alcohols with dicarboxylic acids in the presence of polyurethane catalysts, chain-extending and/or crosslinking agents, blowing agents and further auxiliary and admixture agents is known and has been described in numerous patent and literature publications.

In the context of the present disclosure, the terms “polyester polyol”, “polyesterol”, “polyester alcohol” and the abbreviation “PESOL” are used interchangeably.

Customary polyester polyols are polycondensates of aromatic and/or aliphatic dicarboxylic acids and alkanediols and/or -triols, or ether diols. However it is also possible to process polyester scrap, especially polyethylene terephthalate (PET) and/or polybutylene terephthalate (PBT) scrap. A whole series of processes are known and have been described for this purpose. Some processes are based on converting the polyester into a diester of terephthalic acid, for example dimethyl terephthalate. DE-A 100 37 14 and U.S. Pat. No. 5,051,528 describe such transesterifications using methanol and transesterification catalysts.

It is also known that esters based on terephthalic acid are superior to esters based on phthalic acid in terms of burning behavior, as described in WO 2010/043624 for example.

When polyester polyols based on aromatic carboxylic acids or derivatives thereof (such as terephthalic acid or phthalic anhydride) are used to produce rigid polyurethane (PU) foams, the high viscosity of the polyester polyols often has a noticeably adverse effect, since the viscosity of blends with the polyesters rises as a result, which makes mixing with the isocyanate distinctly more difficult.

EP-A 1 058 701 discloses aromatic polyester polyols of low viscosity, which are obtained by transesterifying a mixture of phthalic acid derivatives, diols, polyols and hydrophobic fat-based materials.

In addition, certain systems for producing rigid PU foams, for example those employing glycerol as comparatively high-functionality alcoholic polyester component, can give rise to problems due to insufficient dimensional stability in that the foamed product distorts significantly after demolding or after the pressure section when processed by the double belt process.

Nor has the problem with the behavior of rigid PU foams in the event of fire hitherto been satisfactorily solved for all systems. For example, a toxic compound can form in the event of fire when using trimethylolpropane (TMP) as comparatively high-functionality alcoholic polyester component.

A general problem with the production of rigid foams is the formation of surface defects, preferentially at the interface with metallic outer layers. These foam surface defects cause formation of an uneven metal surface in sandwich elements and thus often lead to visual unacceptability of the product. An improvement in the foam surface reduces the frequency with which such surface defects occur and thus leads to a visual improvement in the surface of sandwich elements.

Rigid polyurethane foams frequently display high brittleness on cutting with severe evolution of dust and high sensitivity on the part of the foam, and also on sawing where particularly the sawing of composite elements with metallic outer layers and a core of polyisocyanurate foam can lead to crack formation in the foam.

It is further generally desirable to provide systems having a very high self-reactivity in order that the use of catalysts may be minimized.

These problems can all be circumvented by using specific polyetherols as comparatively high-functionality alcoholic polyester component for preparing the polyester polyol.

These polyetherols are generally prepared by catalyzed alkoxylation of an OH-functional starter molecule.

The standard alkoxylation catalysts used are basic compounds, especially KOH. Dimetal cyanide (DMC) catalysts or carbenes are also used in some cases.

The KOH catalysts often used for the alkoxylation of OH-functional compounds, however, necessitate a workup step after the reaction to remove the catalyst from the product. This workup normally takes the form of neutralization and subsequent filtration. This will often leave some product in the catalyst to be removed, which reduces the product yield.

It would be desirable to be able to dispense with working up the polyetherols (inter alia because of polyol losses and the necessary capital spend in this part of the plant). However, the routinely chosen KOH catalysis would leave the basic catalyst in the polyetherol, blocking the subsequent acid-catalyzed esterification for preparing polyesterols.

The invention thus has for its object to provide rigid PU foams having the above-described technical advantages while the materials used for this, especially the polyesters based on the specific polyetherols used for this, should be prepared at a minimum of cost and inconvenience (including inter alia with very few workup and purification steps).

### SUMMARY OF THE INVENTION

This and other objects have been achieved by the present invention the first embodiment of which includes a process for producing rigid polyurethane foams or rigid polyisocyanurate foams comprising the reaction of

A) at least one polyisocyanate,

B) at least one polyetherester polyol obtainable by esterification of

b1) 10 to 70 mol % of a dicarboxylic acid composition comprising

b11) 50 to 100 mol %, based on the dicarboxylic acid composition, of one or more aromatic dicarboxylic acids or derivatives thereof,

b12) 0 to 50 mol %, based on said dicarboxylic acid composition b1), of one or more aliphatic dicarboxylic acids or derivatives thereof,

b2) 2 to 30 mol % of one or more fatty acids and/or fatty acid derivatives,

b3) 10 to 70 mol % of one or more aliphatic or cycloaliphatic diols having 2 to 18 carbon atoms or alkoxylates thereof,

b4) 2 to 50 mol % of a polyether polyol having a functionality of not less than 2, prepared by alkoxylating a polyol having a functionality of not less than 2 in the presence of an amine as catalyst,

all based on the total amount of components b1) to b4), wherein said components b1) to b4) sum to 100 mol %,

C) optionally further polyester polyols other than those of component B),

D) at least one polyether polyol, and

E) optionally flame retardants,

F) one or more blowing agents,

G) catalysts, and

H) optionally further auxiliaries or admixture agents,

wherein the mass ratio of total components B) and optionally C) to component D) is at least 7.

In a preferred case of the first embodiment the mass ratio of polyetherester polyols B) to the further polyester polyols C) is at least 0.1, and additionally, in this case, it may be further preferred that no further polyester polyols C) are utilized.

In a second embodiment, the present invention includes the process of the first embodiment and any of the preferred cases wherein the mass ratio of total components B) and C) to component D) is less than 80, preferably less than 40, more preferably less than 30, even more preferably less than 20, yet even more preferably less than 16 and yet still even more preferably less than 13.

In a third embodiment, the present invention includes the first and second embodiments wherein said polyether polyol b4) has a functionality of >2.

In a fourth embodiment, the present invention includes each of embodiments one to three wherein said polyether polyol b4) is prepared by alkoxylating a polyol selected from the group consisting of sorbitol, pentaerythritol, trimethylolpropane, glycerol, polyglycerol and mixtures thereof. In a preferred case of the fourth embodiment, said polyether polyol b4) is prepared by alkoxylation with ethylene oxide.

In a fifth embodiment, the present invention includes each of embodiments one to four 7 wherein said component b11) comprises one or more compounds selected from the group consisting of terephthalic acid, dimethyl terephthalate, polyethylene terephthalate, phthalic acid, phthalic anhydride and isophthalic acid.

In a sixth embodiment, the present invention includes each of embodiments one to five 8 wherein said dicarboxylic acid composition b1) comprises no aliphatic dicarboxylic acids b12).

In a preferred case of any of embodiments one to six according to the present invention said fatty acid or fatty acid derivative b2) is selected from the group consisting of castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, and fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid. In a highly preferred case of any of embodiments one to six, said fatty acid or fatty acid derivative b2) is selected from the group consisting of oleic acid and methyl oleate.

In a seventh embodiment, the present invention includes any of embodiments one to six, wherein said aliphatic or cycloaliphatic diols b3) are selected from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentanediol and alkoxylates thereof.

In an eighth embodiment, the present invention includes any of embodiments one to seven, wherein said polyetherol component D) consists of polyoxypropylene polyols and/or polyoxyethylene polyols, preferably polyoxyethylene polyols. In a preferred case of the eighth embodiment, said polyetherol component D) consists exclusively of polyethylene glycol and does not comprise any further polyetherols.

In a ninth embodiment, the present invention includes any of embodiments one to eight, wherein said flame retardants E) have no isocyanate-reactive groups.

In a tenth embodiment, the present invention includes any of embodiments one to nine, wherein said blowing agents F) comprise chemical and physical blowing agents, wherein the chemical blowing agent is selected from the group water, formic acid-water mixtures and formic acid, preferably formic acid-water mixtures and formic acid and the physical blowing agent consists of one or more pentane isomers.

In an eleventh embodiment, the present invention includes a rigid polyurethane or polyisocyanurate foam obtained from the process according to any of embodiments one to ten.

In a twelfth embodiment, the present invention includes sandwich elements having rigid or flexible outer layers comprising the rigid polyurethane or polyisocyanurate foams according to the eleventh embodiment.

In a thirteenth embodiment, the present invention includes a polyol component for producing rigid polyurethane foams comprising
10 to 90 wt % of polyetherester polyols B),
0 to 60 wt % of further polyester polyols C),
0.1 to 11 wt % of polyether polyols D),
2 to 50 wt % of flame retardants E),
1 to 45 wt % of blowing agents F),
0.5 to 10 wt % of catalysts G),
0.5 to 20 wt % of further auxiliary and admixture agents H),

said components B) to H) as defined in embodiments one to ten and all based on the total weight of components B) to H), wherein the wt % add up to 100 wt %, and wherein the mass ratio of total components B) and optionally C) to component D) is at least 7. In a preferred case of the thirteenth embodiment, the mass ratio of total components B) and C) to component D) is less than 80, preferably less than 40, more preferably less than 30, even more preferably less than 20, yet even more preferably less than 16 and yet still even more preferably less than 13.

### DETAILED DESCRIPTION OF THE INVENTION

In the first embodiment, the present invention provides a process for producing rigid polyurethane foams or rigid polyisocyanurate foams comprising the reaction of

A) at least one polyisocyanate,
B) at least one polyetherester polyol obtainable by esterification of
b1) 10 to 70 mol % of a dicarboxylic acid composition comprising
   b11) 50 to 100 mol %, based on the dicarboxylic acid composition, of one or more aromatic dicarboxylic acids or derivatives thereof,
   b12) 0 to 50 mol %, based on said dicarboxylic acid composition b1), of one or more aliphatic dicarboxylic acids or derivatives thereof,
b2) 2 to 30 mol % of one or more fatty acids and/or fatty acid derivatives,
b3) 10 to 70 mol % of one or more aliphatic or cycloaliphatic diols having 2 to 18 carbon atoms or alkoxylates thereof,
b4) 2 to 50 mol % of a polyether polyol having a functionality of not less than 2, prepared by alkoxylating a polyol having a functionality of not less than 2 in the presence of an amine as catalyst,
all based on the total amount of components b1) to b4), wherein said components b1) to b4) sum to 100 mol %,
   C) optionally further polyester polyols other than those of component B),
   D) at least one polyether polyol, and
   E) optionally flame retardants,
   F) one or more blowing agents,
   G) catalysts, and
   H) optionally further auxiliaries or admixture agents,
   wherein the mass ratio of total components B) and optionally C) to component D) is at least 7.

Surprisingly, the polyether polyols b4) prepared in the presence of an amine as catalyst can be used without workup step and without other disadvantages in the subsequent acid-catalyzed esterification even though the basic, aminic alkoxylation catalyst remains in the polyether polyol b4).

The present invention also provides a polyol component comprising the aforementioned components B) to H), wherein the mass ratio of total components B) and optionally C) to component D) is at least 7.

The present invention further provides rigid polyurethane and rigid polyisocyanurate foams obtainable from the process of the present invention, and their use for producing sandwich elements having rigid or flexible outer layers.

The invention will now be more particularly described. Combinations of preferred embodiments are not outside the scope of the present invention. This applies particularly in respect of those embodiments of the individual components A) to H) of the present invention that are characterized as preferred. The embodiments recited hereinbelow in the context of components B) to H) relate not only to the process of the present invention and the rigid foams thus obtainable but also to the polyol components of the present invention.

### Component B

In the context of the present disclosure, the terms “polyester polyol” and “polyesterol” are used interchangeably as are the terms “polyether polyol” and “polyetherol”.

Component b11) preferably comprises at least one compound selected from the group consisting of terephthalic acid, dimethyl terephthalate (DMT), polyethylene terephthalate (PET), phthalic acid, phthalic anhydride (PA) and isophthalic acid. It is particularly preferable for component b11) to comprise at least one compound from the group consisting of terephthalic acid, dimethyl terephthalate (DMT), polyethylene terephthalate (PET) and phthalic anhydride (PA). It is very particularly preferable for component b11) to comprise phthalic anhydride, dimethyl terephthalate (DMT), terephthalic acid or mixtures thereof. The component b11) aromatic dicarboxylic acids or derivatives thereof are more preferably selected from the aforementioned aromatic dicarboxylic acids and dicarboxylic acid derivatives respectively and specifically from terephthalic acid and/or dimethyl terephthalate (DMT). Terephthalic acid and/or DMT in component b11) leads to polyether esters B) having particularly good fire protection properties. Terephthalic acid is very particularly preferable since, in contrast to DMT, the formation of disruptive elimination products can be avoided.

In general, aliphatic dicarboxylic acids or derivatives (component b12)) are comprised in the dicarboxylic acid composition b1) at 0 to 30 mol %, preferably 0 to 10 mol %. It is particularly preferable for the dicarboxylic acid composition b1) to comprise no aliphatic dicarboxylic acids or derivatives thereof and thus to consist, to 100 mol %, of one or more aromatic dicarboxylic acids or derivatives thereof, the aforementioned being preferred.

The component b2) is preferably used in amounts of 3 to 20 mol %, more preferably 5 to 18 mol %.

The component b3) is preferably used in amounts of 20 to 60 mol %, preferably in the range from 25 to 55 mol %, more preferably in the range from 30 to 45 mol %.

The component b4) is preferably used in amounts of 2 to 40 mol %, preferably 8 to 35 mol %, more preferably 15 to 25 mol %.

In one embodiment of the invention, the fatty acid or fatty acid derivative b2) consists of a fatty acid or fatty acid mixture, one or more glycerol esters of fatty acids or of fatty acid mixtures, and/or one or more fatty acid monoesters, for example biodiesel or methyl esters of fatty acids, and it is particularly preferable for component b2) to consist of a fatty acid or fatty acid mixture and/or one or more fatty acid monoesters; more specifically component b2) consists of a fatty acid or fatty acid mixture and/or biodiesel, and component b2) specifically consists of a fatty acid or fatty acid mixture.

In one preferred embodiment of the invention, the fatty acid or fatty acid derivative b2) is selected from the group consisting of castor oil, polyhydroxy fatty acids, ricinoleic acid, stearic acid, hydroxyl-modified oils, grapeseed oil, black cumin oil, pumpkin kernel oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, animal tallow, for example beef dripping, fatty acids, hydroxyl-modified fatty acids, biodiesel, methyl esters of fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid, and mixed fatty acids.

In a particularly preferred embodiment of the present invention, the fatty acid or fatty acid derivative b2) is oleic acid, biodiesel, soybean oil, rapeseed oil or tallow, particularly preferably oleic acid, biodiesel, soybean oil, rapeseed oil or beef dripping, more specifically oleic acid or biodiesel and most specifically oleic acid. The fatty acid or the fatty acid derivative improves, inter alia, the blowing agent solubility in the production of rigid polyurethane foams.

It is very particularly preferable for component b2) not to comprise any triglyceride, especially no oil or fat. The glycerol released from the triglyceride by esterification/transesterification has an adverse effect on the dimensional stability of the rigid foam, as mentioned above. Preferred fatty acids and fatty acid derivatives in the context of component b2) are therefore the fatty acids themselves and also alkyl monoesters of fatty acids or alkyl monoesters of fatty acid mixtures, especially the fatty acids themselves and/or biodiesel.

Preferably, the aliphatic or cycloaliphatic diol b3) is selected from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentanediol and alkoxylates thereof. It is particularly preferable for the aliphatic diol b3) to be monoethylene glycol or diethylene glycol, especially diethylene glycol.

In one preferred embodiment of the present invention, the amine catalyst for preparing component b4) is selected from the group comprising dimethylethanolamine (DMEOA), imidazole and imidazole derivatives and also mixtures thereof, more preferably imidazole.

Preferably, such a polyether polyol b4) having a functionality above 2 is used as was prepared by alkoxylating a polyol having a functionality of not less than 3.

Preferably, the polyether polyol b4) has a functionality greater than 2. It preferably has a functionality of not less than 2.7 and especially of not less than 2.9. In general, it has a functionality of not more than 6, preferably not more than 5 and more preferably not more than 4.

In one embodiment of the present invention, the polyether polyol b4) is obtainable by reacting a polyol having a functionality of greater than 2 with ethylene oxide and/or propylene oxide, preferably with ethylene oxide. It is particularly preferable for the polyether polyol b4) to be obtainable by alkoxylation with ethylene oxide, leading to rigid polyurethane foams having improved fire protection properties.

Preferably, the polyether polyol b4) is obtainable by alkoxylating, preferably ethoxylating, a polyol selected from the group consisting of sorbitol, pentaerythritol, trimethylolpropane, glycerol, polyglycerol and mixtures thereof, and more preferably a polyol selected from the group consisting of trimethylolpropane and glycerol.

In a specific embodiment of the invention, the polyether polyol b4) consists of the reaction product of glycerol with ethylene oxide and/or propylene oxide, preferably with ethylene oxide. This results in a particularly high storage stability for component B.

In a further specific embodiment of the invention, the polyether polyol b4) consists of the reaction product of trimethylolpropane with ethylene oxide and/or propylene oxide, preferably with ethylene oxide. This likewise results in a particularly high improved storage stability for component B).

Preferably, the polyether polyol b4) has an OH number in the range from 150 to 1250 mg KOH/g, preferably from 300 to 950 mg KOH/g, particularly preferably from 500 to 800 mg KOH/g. In this range, particularly favorable mechanical properties and also fire protection properties are obtainable.

In a particularly preferred embodiment of the invention, the polyether polyol b4) consists of the reaction product of trimethylolpropane or glycerol, preferably glycerol, with ethylene oxide, wherein the OH number of polyether polyol b4) is in the range from 500 to 800 mg KOH/g and preferably from 500 to 650 mg KOH/g, and imidazole is used as alkoxylation catalyst.

In an especially preferred embodiment of the invention, the polyether polyol b4) consists of the reaction product of trimethylolpropane or glycerol, preferably glycerol, with ethylene oxide, wherein the OH number of polyether polyol b4) is in the range from 500 to 800 mg KOH/g and preferably from 500 to 650 mg KOH/g, imidazole is used as alkoxylation catalyst, the aliphatic or cycloaliphatic diol b3) is diethylene glycol, and the fatty acid or fatty acid derivative b2) is oleic acid.

Preferably, at least 200 mmol, more preferably at least 400 mmol, even more preferably at least 600 mmol, yet even more preferably at least 800 mmol and yet still even more preferably at least 1000 mmol of component b4) are used per kg of polyetherester polyol B).

The number-weighted average functionality of polyetherester polyol B) is preferably not less than 2, more preferably greater than 2, even more preferably greater than 2.2 and especially greater than 2.3, which leads to a higher crosslink density on the part of the polyurethane produced therewith and hence to better mechanical properties on the part of the polyurethane foam.

To prepare the polyetherester polyols, the aliphatic and aromatic polycarboxylic acids and/or derivatives and polyhydric alcohols can be polycondensed in the absence of catalysts or preferably in the presence of esterification catalysts, advantageously in an atmosphere of inert gas, e.g. nitrogen, in the melt at temperatures of from 150 to 280° C., preferably from 180 to 260° C., optionally under reduced pressure, to the desired acid number which is advantageously less than 10, preferably less than 2. In a preferred embodiment, the esterification mixture is polycondensed at the abovementioned temperatures to an acid number of from 80 to 20, preferably from 40 to 20, under atmospheric pressure and subsequently under a pressure of less than 500 mbar, preferably from 40 to 400 mbar. Possible esterification catalysts are, for example, iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entrainers such as, e.g., benzene, toluene, xylene or chlorobenzene in order to distill off the water of condensation as an azeotrope.

To prepare the polyetherester polyols, the organic polycarboxylic acids and/or derivatives and polyhydric alcohols are advantageously polycondensed in a molar ratio of 1:1-2.2, preferably 1:1.05-2.1 and particularly preferably 1:1.1-2.0.

The polyetherester polyols obtained generally have a number-average molecular weight in the range from 300 to 3000, preferably in the range from 400 to 1000 and especially in the range from 450 to 800.

The proportion of polyetherester polyols B) according to the present invention is generally at least 10 wt %, preferably at least 20 wt %, more preferably at least 40 wt % and even more preferably at least 50 wt %, based on total components B) to H).

To produce the rigid polyurethane foams by the process of the invention, use is made of, in addition to the above-described specific polyester polyols (polyetherester polyols B), the constructional components which are known per se, about which the following details may be provided.

### Component A

A polyisocyanate for the purposes of the present invention is an organic compound comprising two or more than two reactive isocyanate groups per molecule, i.e., the functionality is not less than 2. When the polyisocyanates used or a mixture of two or more polyisocyanates do not have a unitary functionality, the number-weighted average functionality of component A) used will be not less than 2.

Useful polyisocyanates A) include the aliphatic, cycloaliphatic, araliphatic and preferably aromatic polyfunctional isocyanates which are known per se. Polyfunctional isocyanates of this type are known per se or are obtainable by methods known per se. Polyfunctional isocyanates can more particularly also be used as mixtures, in which case component A) comprises various polyfunctional isocyanates. The number of isocyanate groups per molecule in polyfunctional isocyanates useful as polyisocyanate is two (and so the polyfunctional isocyanates in question are referred to hereinbelow as diisocyanates) or more than two.

Particularly the following may be mentioned in detail: alkylene diisocyanates having 4 to 12 carbon atoms in the alkylene radical, such as 1,12-dodecane diisocyanate, 2-ethyltetra-methylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates such as cyclohexane 1,3- and 1,4-diisocyanate and also any desired mixtures of these isomers, 1-isocyanato-3,3,5-trimethyl-5-isocyanatomethylcyclohexane (IPDI), 2,4- and 2,6-hexahydro-tolylene diisocyanate and also the corresponding isomeric mixtures, 4,4′-, 2,2′- and 2,4′-dicyclo-hexylmethane diisocyanate and also the corresponding isomeric mixtures, and preferably aromatic polyisocyanates, such as 2,4- and 2,6-tolylene diisocyanate and the corresponding isomeric mixtures, 4,4′-, 2,4′- and 2,2′-diphenylmethane diisocyanate and the corresponding isomeric mixtures, mixtures of 4,4′- and 2,2′-diphenylmethane diisocyanates, polyphenyl-polymethylene polyisocyanates, mixtures of 4,4′-, 2,4′- and 2,2′-diphenylmethane diisocyanates and polyphenylpolymethylene polyisocyanates (crude MDI) and mixtures of crude MDI and tolylene diisocyanates.

Of particular suitability are 2,2′-, 2,4′- and/or 4,4′-diphenylmethane diisocyanate (MDI), 1,5-naphthylene diisocyanate (NDI), 2,4- and/or 2,6-tolylene diisocyanate (TDI), 3,3′-dimethyl-biphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpenta-methylene 1,5-diisocyanate, 2-ethylbutylene 1,4-diisocyanate, pentamethylene 1,5-diiso-cyanate, butylene 1,4-diisocyanate, 1-isocyanato-3,3,5-trimethyl-5-isocyanatomethyl-cyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and 4,4′-, 2,4′- and/or 2,2′-dicyclohexylmethane diisocyanate.

Frequent use is also made of modified polyisocyanates, i.e. products obtained by chemical conversion of organic polyisocyanates and having two or more than two reactive isocyanate groups per molecule. Polyisocyanates comprising ester, urea, biuret, allophanate, carbodiimide, isocyanurate, uretdione, carbamate and/or urethane groups may be mentioned in particular.

The following embodiments are particularly preferable as polyisocyanates of component A):
i) polyfunctional isocyanates based on tolylene diisocyanate (TDI), especially 2,4-TDI or 2,6-TDI or mixtures of 2,4- and 2,6-TDI;
ii) polyfunctional isocyanates based on diphenylmethane diisocyanate (MDI), especially 2,2′-MDI or 2,4′-MDI or 4,4′-MDI or oligomeric MDI, which is also known as polyphenyl-polymethylene isocyanate, or mixtures of two or three aforementioned diphenylmethane diisocyanates, or crude MDI, which is obtained in the production of MDI, or mixtures of at least one oligomer of MDI and at least one aforementioned low molecular weight MDI derivative;
iii) mixtures of at least one aromatic isocyanate as per embodiment i) and at least one aromatic isocyanate as per embodiment ii).

Polymeric diphenylmethane diisocyanate is very particularly preferred as polyisocyanate. Polymeric diphenylmethane diisocyanate (called polymeric MDI hereinbelow) is a mixture of binuclear MDI and oligomeric condensation products and thus derivatives of diphenylmethane diisocyanate (MDI). Polyisocyanates may preferably also be constructed from mixtures of monomeric aromatic diisocyanates and polymeric MDI.

Polymeric MDI, in addition to binuclear MDI, comprises one or more polynuclear condensation products of MDI with a functionality of more than 2, especially 3 or 4 or 5. Polymeric MDI is known and often referred to as polyphenylpolymethylene isocyanate or else as oligomeric MDI. Polymeric MDI is typically constructed from a mixture of MDI-based isocyanates of differing functionality. Polymeric MDI is typically used in admixture with monomeric MDI.

The (average) functionality of a polyisocyanate comprising polymeric MDI can vary in the range from about 2.2 to about 5, especially from 2.3 to 4, especially from 2.4 to 3.5. Crude MDI, obtained as an intermediate in the production of MDI, is more particularly such a mixture of MDI-based polyfunctional isocyanates having different functionalities.

Polyfunctional isocyanates or mixtures of two or more polyfunctional isocyanates based on MDI are known and available for example from BASF Polyurethanes GmbH under the name of Lupranat®.

The functionality of component A) is preferably at least two, especially at least 2.2 and more preferably at least 2.4. The functionality of component A) is preferably from 2.2 to 4 and more preferably from 2.4 to 3.

The isocyanate group content of component A) is preferably from 5 to 10 mmol/g, especially from 6 to 9 mmol/g and more preferably from 7 to 8.5 mmol/g. A person skilled in the art is aware of a reciprocal relationship between the isocyanate group content in mmol/g and the so-called equivalence weight in g/equivalent. The isocyanate group content in mmol/g is obtained from the content in wt % according to ASTM D-5155-96 A.

In a particularly preferred embodiment, component A) consists of at least one polyfunctional isocyanate selected from diphenylmethane 4,4′-diisocyanate, diphenylmethane 2,4′-diiso-cyanate, diphenylmethane 2,2′-diisocyanate and oligomeric diphenylmethane diisocyanate. In this preferred embodiment, component (al) more preferably comprises oligomeric diphenylmethane diisocyanate and has a functionality of at least 2.4.

The viscosity of component A) used can vary within wide limits. The viscosity of component A) is preferably in the range from 100 to 3000 mPa·s and more preferably in the range from 200 to 2500 mPa·s.

### Component C

Suitable polyester polyols C) differ from polyetherester polyols B) and can be prepared, for example, from organic dicarboxylic acids having 2 to 12 carbon atoms, preferably aromatic ones, or mixtures of aromatic and aliphatic dicarboxylic acids, and polyhydric alcohols, preferably diols, having 2 to 12 carbon atoms and preferably 2 to 6 carbon atoms.

Possible dicarboxylic acids are, in particular: succinic acid, glutaric acid, adipic acid, suberic acid, azelaic acid, sebacic acid, decanedicarboxylic acid, maleic acid, fumaric acid, phthalic acid, isophthalic acid and terephthalic acid. It is likewise possible to use derivatives of these dicarboxylic acids, such as dimethyl terephthalate, for example. The dicarboxylic acids can be used either individually or in admixture with one another. It is also possible to use the corresponding dicarboxylic acid derivatives, e.g. dicarboxylic esters of alcohols having from 1 to 4 carbon atoms or dicarboxylic anhydrides, in place of the free dicarboxylic acids. As aromatic dicarboxylic acids, preference is given to using phthalic acid, phthalic anhydride, terephthalic acid and/or isophthalic acid as a mixture or alone. As aliphatic dicarboxylic acids, preference is given to using dicarboxylic acid mixtures of succinic, glutaric and adipic acid in weight ratios of, for example, 20-35: 35-50: 20-32 parts by weight and in particular adipic acid. Examples of dihydric and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, trimethylolpropane and pentaerythritol. Preference is given to using ethanediol, diethylene glycol, 1,4-butanediol, 1,5-pentanediol, 1,6-hexanediol or mixtures of at least two of the diols mentioned, in particular mixtures of 1,4-butanediol, 1,5-pentanediol and 1,6-hexanediol. It is also possible to use polyester polyols derived from lactones, e.g., ε-caprolactone, or hydroxycarboxylic acids, e.g., ω-hydroxycaproic acid.

To prepare the further polyester polyols C), biobased starting materials and/or derivatives thereof are also suitable, for example castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

The mass ratio of polyetherester polyols B) to polyester polyols C) is generally at least 0.1, preferably at least 0.25, more preferably at least 0.5 and especially at least 0.8. Preferably, the proportion of total polyester polyols B) and C) which is attributable to polyetherester polyols B) is at least 25 wt %, preferably at least 50 wt %, more preferably at least 75 wt % and especially 100 wt %. It is particularly preferable when no further polyester polyols C) are utilized.

### Component D

One or more polyether polyols D) are used, according to the present invention, as component D). Polyetherols D) can be prepared by known methods, for example by anionic polymerization of one or more alkylene oxides having from 2 to 4 carbon atoms using alkali metal hydroxides, e.g., sodium or potassium hydroxide, or alkali metal alkoxides, e.g., sodium methoxide, sodium or potassium ethoxide or potassium isopropoxide, or aminic alkoxylation catalysts, such as dimethylethanolamine (DMEOA), imidazole and/or imidazole derivatives, with use of at least one starter molecule comprising from 2 to 8, preferably from 2 to 6, reactive hydrogen atoms in bonded form, or by cationic polymerization using Lewis acids, e.g., antimony pentachloride, boron fluoride etherate, or bleaching earth.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Preferred alkylene oxides are propylene oxide and ethylene oxide, with particular preference being given to ethylene oxide.

Possible starter molecules are, for example: water, organic dicarboxylic acids, such as succinic acid, adipic acid, phthalic acid and terephthalic acid, aliphatic and aromatic, optionally N-mono-alkyl-, N,N-dialkyl- and N,N′-dialkyl-substituted diamines having from 1 to 4 carbon atoms in the alkyl radical, e.g. optionally monoalkyl- and dialkyl-substituted ethylenediamine, diethylene-triamine, triethylenetetramine, 1,3-propylenediamine, 1,3- or 1,4-butylenediamine, 1,2-, 1,3-, 1,4-, 1,5- and 1,6-hexamethylenediamine, phenylenediamines, 2,3-, 2,4- and 2,6-tolylene-diamine and 4,4′-, 2,4′- and 2,2′-diaminodiphenylmethane. Particular preference is given to the recited diprimary amines, for example ethylenediamine.

Further possible starter molecules are: alkanolamines such as ethanolamine, N-methyl-ethanolamine and N-ethylethanolamine, dialkanolamines, such as diethanolamine, N-methyl-diethanolamine and N-ethyldiethanolamine and trialkanolamines, e.g., triethanolamine, and ammonia.

Preference is given to using dihydric or polyhydric alcohols, e.g., ethanediol, 1,2- and 1,3-propanediol, diethylene glycol (DEG), dipropylene glycol, 1,4-butanediol, 1,6-hexanediol, glycerol, trimethylolpropane, pentaerythritol, sorbitol and sucrose.

Polyether polyols D), preferably polyoxypropylene polyols and polyoxyethylene polyols, more preferably polyoxyethylene polyols, have a functionality of preferably 2 to 6, more preferably 2 to 4, especially 2 to 3 and specifically 2 and number-average molecular weights of 150 to 3000 g/mol, preferably 200 to 2000 g/mol and especially 250 to 1000 g/mol.

One preferred embodiment of the invention utilizes an alkoxylated diol, preferably an ethoxylated diol, for example ethoxylated ethylene glycol, as polyether polyol D), preferably polyethylene glycol is concerned.

In a specific embodiment of the invention, the polyetherol component D) consists exclusively of polyethylene glycol, preferably with a number-average molecular weight of 250 to 1000 g/mol.

The proportion of polyether polyols D) is generally in the range from 0 to 11 wt %, preferably in the range from 2 to 9 wt % and more preferably in the range from 4 to 8 wt %, based on total components B) to H).

The mass ratio of total components B) and C) to component D) in accordance with the present invention is greater than 7, preferably greater than 7.5, more preferably greater than 8, even more preferably greater than 10 and yet even more preferably greater than 12.

The mass ratio of total components B) and C) to component D) in accordance with the present invention is further less than 80, preferably less than 40, more preferably less than 30, even more preferably less than 20, yet even more preferably less than 16 and yet still even more preferably less than 13.

### Component E

As flame retardants E), it is generally possible to use the flame retardants known from the prior art. Suitable flame retardants are, for example, brominated esters, brominated ethers (Ixol) or brominated alcohols such as dibromoneopentyl alcohol, tribromoneopentyl alcohol and PHT-4-diol and also chlorinated phosphates such as tris(2-chloroethyl) phosphate, tris(2-chloropropyl) phosphate (TCPP), tris(1,3-dichloropropyl)phosphate, tricresyl phosphate, tris(2,3-dibromo-propyl)phosphate, tetrakis(2-chloroethyl)ethylenediphosphate, dimethyl methanephosphonate, diethyl diethanolaminomethylphosphonate and also commercial halogen-comprising flame retardant polyols. By way of further phosphates or phosphonates it is possible to use diethyl ethanephosphonate (DEEP), triethyl phosphate (TEP), dimethyl propylphosphonate (DMPP) or diphenyl cresyl phosphate (DPK) as liquid flame retardants.

Apart from the abovementioned flame retardants, it is also possible to use inorganic or organic flame retardants such as red phosphorus, preparations comprising red phosphorus, aluminum oxide hydrate, antimony trioxide, arsenic oxide, ammonium polyphosphate and calcium sulfate, expandable graphite or cyanuric acid derivatives such as melamine, or mixtures of at least two flame retardants, e.g. ammonium polyphosphates and melamine and optionally maize starch or ammonium polyphosphate, melamine, expandable graphite and optionally aromatic polyesters for making the rigid polyurethane foams flame resistant.

Preferable flame retardants have no isocyanate-reactive groups. The flame retardants are preferably liquid at room temperature. Particular preference is given to TCPP, DEEP, TEP, DMPP and DPK.

The proportion of flame retardant E) is generally in the range from 2 to 50 wt %, preferably in the range from 5 to 30 wt % and more preferably in the range from 8 to 25 wt %, based on components B) to H).

### Component F

Blowing agents F) which are used for producing the rigid polyurethane foams include preferably water, formic acid and mixtures thereof. These react with isocyanate groups to form carbon dioxide and in the case of formic acid carbon dioxide and carbon monoxide. Since these blowing agents release the gas through a chemical reaction with the isocyanate groups, they are termed chemical blowing agents. In addition, physical blowing agents such as low-boiling hydrocarbons can be used. Suitable in particular are liquids which are inert towards the polyisocyanates A) and have boiling points below 100° C., preferably below 50° C., at atmospheric pressure, so that they vaporize under the conditions of the exothermic polyaddition reaction. Examples of such liquids which can preferably be used are alkanes such as heptane, hexane, n-pentane and isopentane, preferably industrial mixtures of n-pentane and isopentane, n-butane and isobutane and propane, cycloalkanes such as cyclopentane and/or cyclohexane, ethers such as furan, dimethyl ether and diethyl ether, ketones such as acetone and methyl ethyl ketone, alkyl carboxylates such as methyl formate, dimethyl oxalate and ethyl acetate and halogenated hydrocarbons such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane and heptafluoropropane. Mixtures of these low-boiling liquids with one another and/or with other substituted or unsubstituted hydrocarbons can also be used. Organic carboxylic acids such as formic acid, acetic acid, oxalic acid, ricinoleic acid and carboxyl-containing compounds are also suitable.

It is preferable not to use any halogenated hydrocarbons as blowing agents. It is preferable to use water, formic acid-water mixtures or formic acid as chemical blowing agents and formic acid-water mixtures or formic acid are particularly preferred chemical blowing agents. Pentane isomers or mixtures of pentane isomers are preferably used as physical blowing agents.

The chemical blowing agents can be used alone, i.e., without addition of physical blowing agents, or together with physical blowing agents. Preferably, the chemical blowing agents are used together with physical blowing agents, in which case the use of formic acid-water mixtures or pure formic acid together with pentane isomers or mixtures of pentane isomers is preferred.

The blowing agents are either wholly or partly dissolved in the polyol component (i.e. B+C+D+E+F+G+H) or are introduced via a static mixer immediately before foaming of the polyol component. It is usual for water, formic acid-water mixtures or formic acid to be fully or partially dissolved in the polyol component and the physical blowing agent (for example pentane) and any remainder of the chemical blowing agent to be introduced “on-line”.

The polyol component is admixed in situ with pentane, possibly some of the chemical blowing agent and also with all or some of the catalyst. Auxiliary and admixture agents as well as flame retardants are already comprised in the polyol blend.

The amount of blowing agent or blowing agent mixture used is in the range from 1 to 45 wt %, preferably in the range from 1 to 30 wt % and more preferably in the range from 1.5 to 20 wt %, all based on total components B) to H).

When water, formic acid or a formic acid-water mixture is used as blowing agent, it is preferably added to the polyol component (B+C+D+E+F+G+H) in an amount of 0.2 to 10 wt %, based on component B). The addition of water, formic acid or formic acid-water mixture can take place in combination with the use of other blowing agents described. Preference is given to using formic acid or a formic acid-water mixture in combination with pentane.

### Component G

Catalysts G) used for preparing the rigid polyurethane foams are particularly compounds which substantially speed up the reaction of the components B) to H) compounds comprising reactive hydrogen atoms, especially hydroxyl groups, with the polyisocyanates A).

It is advantageous to use basic polyurethane catalysts, for example tertiary amines such as triethylamine, tributylamine, dimethylbenzylamine, dicyclohexylmethylamine, dimethylcyclo-hexylamine, N,N,N′,N′-tetramethyldiaminodiethyl ether, bis(dimethylaminopropyl)urea, N-methylmorpholine or N-ethylmorpholine, N-cyclohexylmorpholine, N,N,N′,N′-tetra-methylethylenediamine, N,N,N,N-tetramethylbutanediamine, N,N,N,N-tetramethylhexane-1,6-diamine, pentamethyldiethylenetriamine, bis(2-dimethylaminoethyl)ether, dimethylpiperazine, N-dimethylaminoethylpiperidine, 1,2-dimethylimidazole, 1-azabicyclo[2.2.0]octane, 1,4-diaza-bicyclo[2.2.2]octane (Dabco) and alkanolamine compounds, such as triethanolamine, triisopropanolamine, N-methyldiethanolamine and N-ethyldiethanolamine, dimethylamino-ethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, and triethylenediamine. However, metal salts such as iron(II) chloride, zinc chloride, lead octoate and preferably tin salts such as tin dioctoate, tin diethylhexoate and dibutyltin dilaurate and also, in particular, mixtures of tertiary amines and organic tin salts are also suitable.

Further possible catalysts are: amidines such as 2,3-dimethyl-3,4,5,6-tetrahydropyrimidine, tetraalkylammonium hydroxides such as tetramethylammonium hydroxide, alkali metal hydroxides such as sodium hydroxide and alkali metal alkoxides such as sodium methoxide and potassium isopropoxide, alkali metal carboxylates and also alkali metal salts of long-chain fatty acids having from 10 to 20 carbon atoms and optionally lateral OH groups. Preference is given to using from 0.001 to 10 parts by weight of catalyst or catalyst combination, based (i.e., reckoned) on 100 parts by weight of component B). It is also possible to allow the reactions to proceed without catalysis. In this case, the catalytic activity of amine-started polyols is exploited.

When, during foaming, a relatively large polyisocyanate excess is used, further suitable catalysts for the trimerization reaction of the excess NCO groups with one another are: catalysts which form isocyanurate groups, for example ammonium ion salts or alkali metal salts, specifically ammonium or alkali metal carboxylates, either alone or in combination with tertiary amines. Isocyanurate formation leads to flame-resistant PIR foams which are preferably used in industrial rigid foam, for example in building and construction as insulation boards or sandwich elements.

Further information regarding the abovementioned and further starting materials may be found in the technical literature, for example Kunststoffhandbuch, Volume VII, Polyurethane, Carl Hanser Verlag Munich, Vienna, 1st, 2nd and 3rd Editions 1966, 1983 and 1993.

### Component H

Further auxiliaries and/or admixture agents H) can optionally be added to the reaction mixture for producing the rigid polyurethane foams. Mention may be made of, for example, surface-active substances, foam stabilizers, cell regulators, fillers, dyes, pigments, hydrolysis inhibitors, fungistatic and bacteriostatic substances.

Possible surface-active substances are, for example, compounds which serve to aid homogenization of the starting materials and may also be suitable for regulating the cell structure of the polymers. Mention may be made of, for example, emulsifiers such as the sodium salts of castor oil sulfates or of fatty acids and also salts of fatty acids with amines, e.g. diethylamine oleate, diethanolamine stearate, diethanolamine ricinoleate, salts of sulfonic acids, e.g. alkali metal or ammonium salts of dodecylbenzenedisulfonic or dinaphthylmethane-disulfonic acid and ricinoleic acid; foam stabilizers such as siloxane-oxyalkylene copolymers and other organopolysiloxanes, ethoxylated alkylphenols, ethoxylated fatty alcohols, paraffin oils, castor oil esters or ricinoleic esters, Turkey red oil and peanut oil, and cell regulators such as paraffins, fatty alcohols and dimethylpolysiloxanes. The above-described oligomeric acrylates having polyoxyalkylene and fluoroalkane radicals as side groups are also suitable for improving the emulsifying action, the cell structure and/or for stabilizing the foam. The surface-active substances are usually employed in amounts of from 0.01 to 10 parts by weight, based (i.e., reckoned) on 100 parts by weight of component B).

For the purposes of the present invention, fillers, in particular reinforcing fillers, are the customary organic and inorganic fillers, reinforcing materials, weighting agents, agents for improving the abrasion behavior in paints, coating compositions, etc., which are known per se. Specific examples are: inorganic fillers such as siliceous minerals, for example sheet silicates such as antigorite, serpentine, hornblendes, amphiboles, chrisotile and talc, metal oxides such as kaolin, aluminum oxides, titanium oxides and iron oxides, metal salts, such as chalk, barite and inorganic pigments such as cadmium sulfide and zinc sulfide and also glass, etc. Preference is given to using kaolin (china clay), aluminum silicate and coprecipitates of barium sulfate and aluminum silicate and also natural and synthetic fibrous minerals such as wollastonite, metal fibers and in particular glass fibers of various length, which may be coated with a size. Possible organic fillers are, for example: carbon, melamine, rosin, cyclopentadienyl resins and graft polymers and also cellulose fibers, polyamide, polyacrylonitrile, polyurethane, polyester fibers based on aromatic and/or aliphatic dicarboxylic esters and in particular carbon fibers.

The inorganic and organic fillers can be used individually or as mixtures and are advantageously added to the reaction mixture in amounts of from 0.5 to 50 wt %, preferably from 1 to 40 wt %, based on the weight of components A) to H), although the content of mats, nonwovens and woven fabrics of natural and synthetic fibers can reach values of up to 80 wt %, based on the weight of components A) to H).

Further information regarding the abovementioned other customary auxiliary and admixture agents may be found in the technical literature, for example the monograph by J. H. Saunders and K. C. Frisch “High Polymers” Volume XVI, Polyurethanes, Parts 1 and 2, Interscience Publishers 1962 and 1964, or Kunststoff-Handbuch, Polyurethane, Volume VII, Hanser-Verlag, Munich, Vienna, 1st and 2nd Editions, 1966 and 1983.

The present invention further provides a polyol component comprising:

10 to 90 wt % of polyetherester polyols B),
0 to 60 wt % of further polyester polyols C),
0.1 to 11 wt % of polyether polyols D),
2 to 50 wt % of flame retardants E),
1 to 45 wt % of blowing agents F),
0.5 to 10 wt % of catalysts G), and
0.5 to 20 wt % of further auxiliary and admixture agents H),
all as defined above and all based on the total weight of components B) to H), wherein the wt % add up to 100 wt %, and wherein the mass ratio of total components B) and C) to component D) is at least 7.

It is particularly preferable for the polyol component to comprise

50 to 90 wt % of polyetherester polyols B),
0 to 20 wt % of further polyester polyols C),
2 to 9 wt % of polyether polyols D),
5 to 30 wt % of flame retardants E),
1 to 30 wt % of blowing agents F),
0.5 to 10 wt % of catalysts G), and
0.5 to 20 wt % of further auxiliary and admixture agents H),
all as defined above and all based on the total weight of components B) to H), wherein the wt % add up to 100 wt %, and wherein the mass ratio of total components B) and C) to component D) is at least 7.5.

The mass ratio of the present invention of total components B) and optionally C) to component D) in the polyol components of the present invention is further preferably less than 80, more preferably less than 40, even more preferably less than 30, yet even more preferably less than 20, yet still even more preferably less than 16 and most preferably less than 13.

To produce the rigid polyurethane foams of the invention, the optionally modified organic polyisocyanates A), the specific polyetherester polyols B) of the invention, optionally the further polyester polyols C), the polyetherols D) and the further components E) to H) are mixed in such amounts that the equivalence ratio of NCO groups of the polyisocyanates A) to the sum of the reactive hydrogen atoms of the components B) and optionally C) and D) to H) is 1-6:1, preferably 1.6-5:1 and in particular 2.5-3.5:1.

The examples which follow illustrate the invention.

### EXAMPLES

The hereinbelow specified polyester polyol (polyesterol 1) and polyetherester polyols (polyesterol 2 and polyesterol 3) were used, the inventive polyesterol 3 having been prepared with a polyetherol which did not have to be worked up between alkoxylation and esterification, since the alkoxylation was carried out in the presence of an aminic alkoxylation catalyst.

Polyester polyol 1 (comparator): Esterification product of terephthalic acid (34 mol %), oleic acid (9 mol %), diethylene glycol (40 mol %) and glycerol (17 mol %) with a hydroxyl functionality of 2.3, a hydroxyl number of 244 mg KOH/g and an oleic acid content of 20 wt % in the polyesterol. Polyester polyol 2 (comparator): Esterification product of terephthalic acid (31 mol %), oleic acid (8 mol %), diethylene glycol (43 mol %) and a polyether (18 mol %) based on glycerol and ethylene oxide having an OH functionality of 3 and a hydroxyl number of 535 mg KOH/g prepared in the presence of KOH as alkoxylation catalyst with subsequent neutralization and removal of the resultant potassium salt. The polyester has a hydroxyl functionality of 2.3, a hydroxyl number of 237 mg KOH/g and an oleic acid content of 15 wt % in the polyesterol.

Polyester polyol 3 (invention): Esterification product of terephthalic acid (31 mol %), oleic acid (8 mol %), diethylene glycol (43 mol %) and a polyether (18 mol %) based on glycerol and ethylene oxide having an OH functionality of 3 and a hydroxyl number of 546 mg KOH/g, prepared in the presence of imidazole as alkoxylation catalyst. This polyether was used in the subsequent esterification without working up. The polyester has a hydroxyl functionality of 2.3, a hydroxyl number of 239 mg KOH/g and an oleic acid content of 15 wt % in the polyester polyol.

### Determination of Dimensional Stability

Dimensional stability is determined by determining element thickness after foaming. For this, a sandwich element with a 0.05 mm thick aluminum foil as outer layer material is produced in the double belt process and element thickness is determined in the center of the element 5 minutes after production. The closer the element thickness thus determined is to the set element thickness (170 mm in the present case), the better the dimensional stability.

### Inventive Example 1 and Comparative Examples 1 and 2

### Production of Rigid Polyurethane Foams (Variant 1)

The isocyanates and also the isocyanate-reactive components were foamed up together with the blowing agents, catalysts and all further admixture agents at a constant polyol component:isocyanate mixing ratio of 100:160.

### Polyol Component:

65 parts by weight of polyesterol as per inventive or comparative examples,
8 parts by weight of polyetherol from ethoxylated ethylene glycol having a hydroxyl functionality of 2 and a hydroxyl number of 190 mg KOH/g,
25 parts by weight of trischloroisopropyl phosphate (TCPP) as flame retardant,
2.0 parts by weight of Tegostab 88443 (silicone-containing) stabilizer.

### Admixture Agents:

about 8 parts by weight of S 80:20 pentane (consisting of 80 wt % n-pentane and 20 wt % isopentane),
1.6 parts by weight of formic acid solution (85 wt % in water),
1.6 parts by weight of potassium formate solution (36 wt % in ethylene glycol),
plus bis(2-dimethylaminoethyl)ether solution (70 wt % in dipropylene glycol) for adjusting the fiber times.

### Isocyanate Component:

160 parts by weight of Lupranat® M50 (polymeric methylene(diphenyl diisocyanate) (PMDI), having a viscosity of about 500 mPa*s at 25° C. from BASF SE).

Sandwich elements 170 mm in thickness were produced by the double belt process. Foam density was adjusted to 38+/−1 g/L by varying the pentane content while keeping the amount of 85% aqueous formic acid solution constant at 1.6 parts. Fiber time was further adjusted to 39+/−1 s by varying the proportion of 70% bis(2-dimethylaminoethyl)ether solution.

The results are summarized in table 1.

TABLE 1
Results of tests to produce 170 mm thick sandwich elements by double
belt process

| | Polyester polyol: | | |
|---|---|---|---|
| | Polyesterol 1 | Polyesterol 2 | |
| | (comparator) | (comparator) | Polyesterol 3 |
| Element | 186 mm | 177 mm | 177 mm |
| thickness after | | | |
| foaming | | | |

It is clearly apparent that the polyetherester polyols (polyesterols 2 and 3) improve the dimensional stability of rigid polyurethane foam, while the synthesis of polyesterol 3, which is in accordance with the present invention, is distinctly facilitated by avoiding the workup step (neutralization and removal of potassium salt). Table 1 shows that this form of task facilitation has no adverse consequences in the end product.

1. A process for producing rigid polyurethane foams or rigid polyisocyanurate foams comprising the reaction of
A) at least one polyisocyanate,
B) at least one polyetherester polyol obtainable by esterification of
b1) 10 to 70 mol % of a dicarboxylic acid composition comprising
b11) 50 to 100 mol %, based on the dicarboxylic acid composition, of one or more aromatic dicarboxylic acids or derivatives thereof,
b12) 0 to 50 mol %, based on said dicarboxylic acid composition b1), of one or more aliphatic dicarboxylic acids or derivatives thereof,
b2) 2 to 30 mol % of one or more fatty acids and/or fatty acid derivatives,
b3) 10 to 70 mol % of one or more aliphatic or cycloaliphatic diols having 2 to 18 carbon atoms or alkoxylates thereof,
b4) 2 to 50 mol % of a polyether polyol having a functionality of not less than 2, prepared by alkoxylating a polyol having a functionality of not less than 2 in the presence of an amine as catalyst,
all based on the total amount of components b1) to b4), wherein said components b1) to b4) sum to 100 mol %,
C) optionally further polyester polyols other than those of component B),
D) at least one polyether polyol, and
E) optionally flame retardants,
F) one or more blowing agents,
G) catalysts, and
H) optionally further auxiliaries or admixture agents,
wherein the mass ratio of total components B) and optionally C) to component D) is at least 7.

2. The process according to claim 1 wherein the mass ratio of polyetherester polyols B) to the further polyester polyols C) is at least 0.1.

3. The process according to claim 2 wherein no further polyester polyols C) are utilized.

4. The process according to claim 1 wherein the mass ratio of total components B) and C) to component D) is less than 80.

5. The process according to claim 1 wherein said polyether polyol b4) has a functionality of >2.

6. The process according to claim 1 wherein said polyether polyol b4) is prepared by alkoxylating a polyol selected from the group consisting of sorbitol, pentaerythritol, trimethylolpropane, glycerol, polyglycerol and mixtures thereof.

7. The process according to claim 1 wherein said polyether polyol b4) is prepared by alkoxylation with ethylene oxide.

8. The process according to claim 1 wherein said component b11) comprises one or more compounds selected from the group consisting of terephthalic acid, dimethyl terephthalate, polyethylene terephthalate, phthalic acid, phthalic anhydride and isophthalic acid.

9. The process according to claim 1 wherein said dicarboxylic acid composition b1) comprises no aliphatic dicarboxylic acids b12).

10. The process according to claim 1 wherein said fatty acid or fatty acid derivative b2) is selected from the group consisting of castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, and fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

11. The process according to claim 10 wherein said fatty acid or fatty acid derivative b2) is selected from the group consisting of oleic acid and methyl oleate.

12. The process according to claim 1 wherein said aliphatic or cycloaliphatic diols b3) are selected from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentanediol and alkoxylates thereof.

13. The process according to claim 1 wherein said polyetherol component D) consists of polyoxypropylene polyols and/or polyoxyethylene polyols.

14. The process according to claim 13 wherein said polyetherol component D) consists exclusively of polyethylene glycol and does not comprise any further polyetherols.

15. The process according to claim 1 wherein said flame retardants E) have no isocyanate-reactive groups.

16. The process according to claim 1 wherein said blowing agents F) comprise chemical and physical blowing agents, wherein the chemical blowing agent is selected from the group water, formic acid-water mixtures and formic acid, and the physical blowing agent consists of one or more pentane isomers.

17. A rigid polyurethane or polyisocyanurate foam obtained by the process according to claim 1.

18. A sandwich element having rigid or flexible outer layers, comprising the rigid polyurethane or polyisocyanurate foam of claim 17.
